(19) United States
(12) Patent Application Publication
(10) Pub. No.: US 2011/0094033 A1
(43) Pub. Date: Apr. 28, 2011

(54) Anti-snore neck-support contour pillow

(75) Inventor: Youn Jae Lee, Pleasanton, CA (US)

(73) Assignee: Zinus Inc.

(21) Appl. No.: 12/589,840

(22) Filed: Oct. 28, 2009

(51) Int. Cl. A47C 20/00; B29C 67/20

(52) U.S. Cl. 5/636; 264/46.4

(57) ABSTRACT

An anti-snore neck-support pillow includes a molded foam body and a fabric covering. The body includes front, back and middle portions. The back portion is thinner than the front portion and thicker than the middle portion. The top surface of the body has a concave curve between the front and back portions. The molded foam conforms around a support member disposed within the front portion. Vertical holes pass completely through the middle portion. The body has a flat bottom surface with an indentation located opposite the concave curve of the top surface. The support member increases the firmness of the foam in the front portion, whereas the holes and the indentation decrease the firmness of the body in the middle portion. The user's head is tilted back when the support member lifts the user's neck, and the holes and indentation allow the user's head to sink into the middle portion.

### TECHNICAL FIELD

The present invention relates to pillows, and in particular to pillows that prevent snoring by supporting the neck.

### BACKGROUND INFORMATION

Traditionally, a pillow has been a generally rectangular pocket of cloth filled with natural feathers or a synthetic resilient material, such as a foam. The pillow stuffing passively conforms to the user's head or can be actively shaped by the user. More recently, however, specialized pillows have been developed with a predetermined contoured shape designed to prevent snoring. The contoured shape tilts the user's head back such that the user's airways remain open.

FIG. 1 (prior art) shows an existing anti-snore pillow 10 with the cloth covering removed. Pillow 10 is intended to reduce snoring by supporting the neck of a user lying supine (face up) such that the user's head tilts back into a depression 11. Pillow 10 includes a pillow body 12 of formed foam, two foam supports 13-14 and three shims 15-17 located under a neck support region 18. Pillow body 12 includes two ear depressions 19-20 for receiving the user's ears when the user is lying on his side.

FIG. 2 (prior art) shows a bottom view of pillow 10. Each of the two foam supports 13-14 is a slab of foam that is glued to the bottom of pillow body 12. Each of the foam supports 13-14 covers about one third of the bottom area of pillow body 12, leaving the central one third uncovered. Foam supports 13-14 form a groove 19 through the central uncovered area of the bottom area of pillow body 12. FIG. 2 shows an indentation in the formed foam of pillow body 12 that deepens groove 19. The shims 15-17 are located along the edge of groove 19 beneath neck support region 18. The shims 15-17 are strips of foam covered by cloth and are attached to each other and to pillow body 12 by adhesive tape, Velcro® or the like. By adding fewer or more shims, the neck support can be adjusted. Because groove 19 is not supported by shims, the user's head depresses into depression 11. Further details of existing anti-snore pillow 10 are disclosed in FIGS. 8-10 and the supporting text of U.S. Pat. No. 6,006,380.

Existing anti-snore pillows such as pillow 10 suffer from various limitations. First, pillow 10 is expensive to manufacture because it includes multiple pieces. Foam supports 13-14 must be formed separately and then aligned with and glued to pillow body 12. Shims 15-17 must also be formed separately, individually inserted into cloth coverings, and then placed at the edge of groove 19 using tape or Velcro. Second, shims 15-17 do not provide adequate support to neck support region 18. The foam within shims 15-17 does not directly support the foam of pillow body 12 but is rather cushioned by the cloth coverings. Moreover, shims 15-17 easily shift and do not remain rigid beneath neck support region 18. In the worst case, shims 15-17 become dislodged from the tape or Velcro and float loosely within the pillow cover. Finally, the user's head may not adequately sink into depression 11. The hardness of the foam of pillow body 12 is the same throughout. The thinner layer of foam above groove 19 is intended to allow the user's head to sink into depression 11. The user's head sinks into depression 11, however, partly as a result of hammocking of the thinner layer of foam above groove 19 as opposed to actually sinking farther into (and being supported by) the foam.

An anti-snore pillow is sought that is both less expensive than existing designs to manufacture and that more effectively tilts back the head of the user.

### SUMMARY

An anti-snore neck-support pillow includes a contoured body of molded memory foam and a fabric covering that encloses the body. The molded foam body includes a front portion with a first thickness, a back portion with a second thickness, and a middle portion with a third thickness. The second thickness is thinner than the first thickness and thicker than the third thickness. The top surface of the body has a concave curve between the front portion and the back portion. The molded foam of the body conforms around a foam support member that is disposed horizontally within the front portion. The molded foam has an indentation load deflection (ILD) in a range of 6-10, whereas the support member has an ILD in a range of 12-14. A plurality of vertical holes pass completely through the middle portion of the molded foam body. Thus, the support member is made of foam having a hardness greater than that of the molded foam of the body. The molded foam body has a substantially flat bottom surface with an indentation located opposite the concave curve of the top surface.

The support member provides a means for increasing the firmness of the foam in the front portion of the body, whereas the vertical holes and the indentation provide a means for decreasing the firmness of the body of molded foam in the middle portion. When the support member lifts the user's neck, and the holes and indentation allow the user's head to sink into the middle portion of the body, the user's head is tilted back, which opens the user's airways. By sufficiently tilting back the head and preventing the user from sleeping with his chin close to his chest, the contoured pillow opens the user's airways and reduces the incidence of snoring and sleep apnea.

In one embodiment, the molded foam of the body contains green tea and a green dye. Bacteria, mites and mold that can live in the fabric covering of the pillow are killed when they come into contact with the green tea foam. The green tea also decreases the smell of the memory foam chemicals of the contour pillow. Adding green dye to make the body look green adds to consumer awareness that the contour pillow contains green tea.

A method of making the anti-snore, neck-support pillow includes removably attaching a support member to the inside surface of the lid of a foam mold, mixing together polyol raw materials for memory foam, adding green tea and green dye, and adding the mixed polyol raw materials, green tea and green dye to the mold. The mold includes a front portion of the mold with a first depth, a back portion of the mold with a second depth, and a middle portion of the mold with a third depth. The second depth is shallower than the first depth and deeper than the third depth. The lid of the mold has a protrusion that extends into the middle portion of the mold when the lid of the mold is closed.

The lid of the mold is then closed such that the support member is disposed horizontally within the front portion of the mold and such that the mixed polyol raw materials conform around the support member. The mixed polyol raw materials are allowed to cure. When the body of molded foam is removed from the mold, the support member is disposed horizontally within the molded foam. The body of molded foam has a substantially flat bottom surface with an indentation made by the protrusion on the lid of the mold. The indentation is located opposite the concave curve of the top surface. A plurality of vertical holes are then punched completely through the body of molded foam in the center of the middle portion.

Further details and embodiments are described in the detailed description below. This summary does not purport to define the invention. The invention is defined by the claims.

### BRIEF DESCRIPTION OF THE DRAWINGS

The accompanying drawings illustrate embodiments of the invention.

FIG. 1 (prior art) is a top perspective view of a prior art adjustable pillow with adjustable neck support and two ear holes.

FIG. 2 (prior art) is a bottom perspective view of the prior art pillow of FIG. 1 showing a groove and head-neck adjustment shims.

FIG. 3 is a top perspective view of a novel anti-snore, neck-support pillow that includes an inner support member and vertical holes through molded foam.

FIG. 4 is a bottom perspective view of the pillow of FIG. 3 with an indentation on its flat bottom surface.

FIG. 5 is another bottom perspective view of the pillow of FIG. 3 showing the support member and vertical holes through the indentation in the molded foam.

FIG. 6 is a top perspective view of a fabric covering enclosing the molded foam body of the pillow of FIG. 3.

FIG. 7 is a top perspective view of another embodiment of the novel neck-support pillow with a contoured neck-support region.

FIG. 8 illustrates the head of a user resting on the neck-support contour pillow of FIG. 7.

FIG. 9 a flowchart of steps of a method of making the novel anti-snore pillow of FIG. 3.

FIG. 10 is a perspective view of a foam mold used to perform the method of FIG. 9.

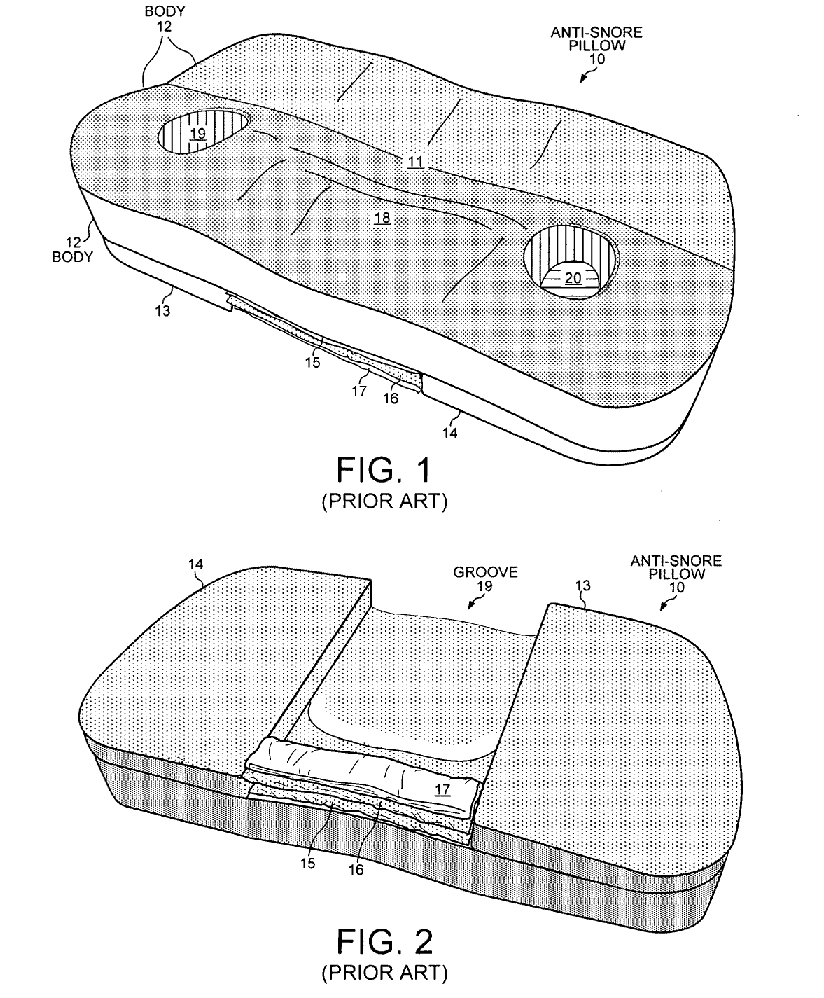

### DETAILED DESCRIPTION

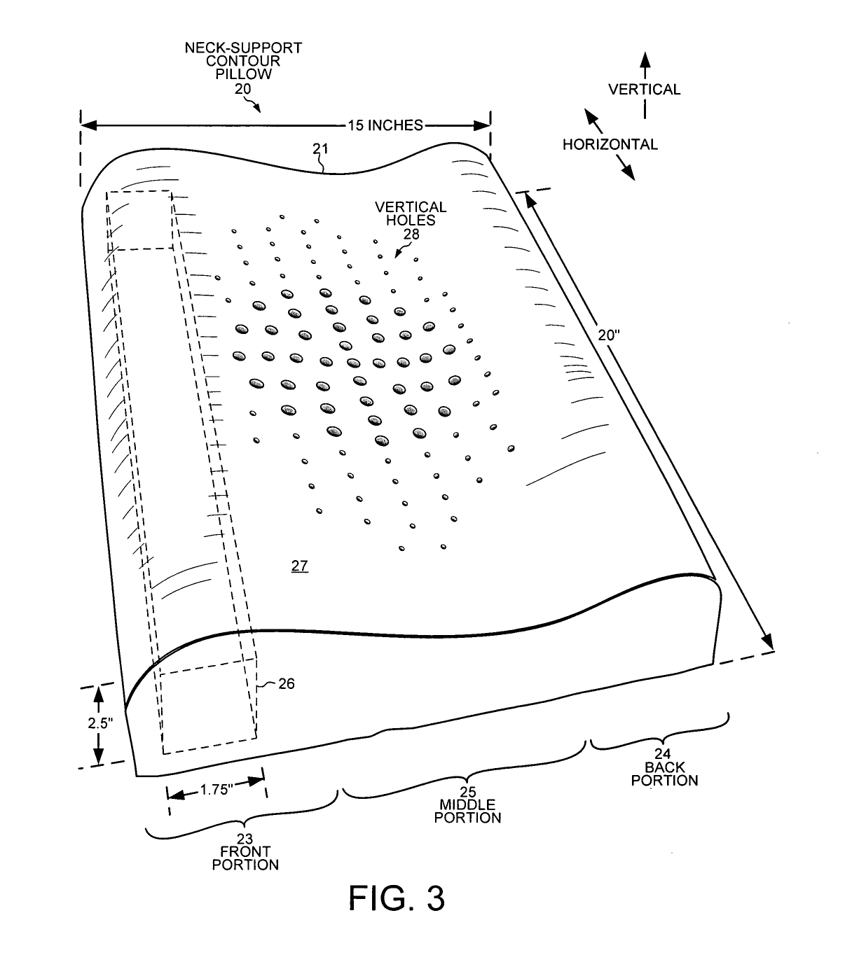

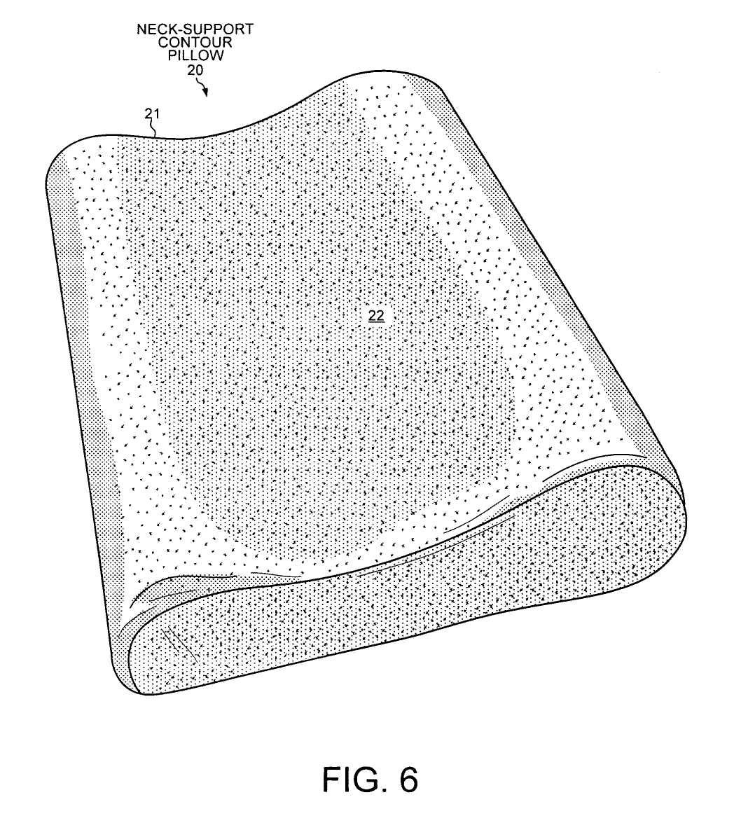

FIG. 3 shows a novel pressure relief pillow 20 with a contoured configuration that both supports the neck and tilts back the head of a user lying face up on the pillow. Neck-support contour pillow 20 includes a body 21 of molded foam and a fabric covering 22 that encloses the body. Fabric covering 22 is removed in FIG. 3 (see FIG. 6). In one embodiment, body 21 of molded foam is about twenty inches wide and fifteen inches long. Body 21 has a front portion 23 with a first thickness, a back portion 24 with a second thickness and a middle portion 25 with a third thickness. In the embodiment of FIG. 3, the second thickness is thinner than the first thickness and thicker than the third thickness. In an alternate embodiment, the first thickness approximately equals the second thickness. The front portion in FIG. 3 is about 3.5 inches thick. Body 21 has a top surface 27 with a concave curve between front portion 23 and back portion 24.

A support member 26 is disposed horizontally within front portion 23 of body 21. Support member 26 is about eighteen inches long, 1.75 inches wide, and 2.5 inches tall. All six sides of support member 26 are planar and rectangular. The molded foam of body 21 conforms around support member 26. In one embodiment, body 21 is made of visco-elastic polyurethane foam that is poured into a mold and thereby molded into the form of contoured pillow 20. Visco-elastic foam is also referred to as “memory” foam. The molded memory foam of body 21 has a hardness corresponding to an indentation load deflection (ILD) in the range of 6-10. The ILD is a measure of the contacting hardness of the foam, which is the force required to compress the foam by a specified percentage in a predetermined manner. A harder foam exhibits a higher ILD. In one embodiment, support member 26 is also made of memory foam. Alternatively, support member 26 is made of high-density polyurethane (HD) foam. Support member 26 is foam cut from a foam slab having an ILD in the range of 12-14. Support member 26 is made of foam having a density of about four pounds per cubic foot, and body 21 is made of foam having a density of about 3.5 pounds per cubic foot. Some types of memory foam tend to become softer in the presence of body heat. When foam is used for support member 26 that does not become softer with body heat, the support provided by support member 26 does not sag during the night as pillow 20 warms up. In yet another embodiment, support member 26 is made of pliable plastic.

FIG. 3 shows a plurality of distributed cylindrical vertical holes 28 that pass completely through body 21 of molded foam at the center of middle portion 25 of body 21. In an alternative embodiment, vertical holes 28 are countersunk holes from the bottom surface of body 21 and do not pass completely through top surface 27. The center of middle portion 25 corresponds to the contact position between pillow 20 and the back of the head of a person reclining thereon. The center of front portion 23 corresponds to the contact position between pillow 20 and the neck of a person reclining thereon. Vertical holes 28 are punched through body 21 after the memory foam has already been molded. Alternatively, holes 28 may be formed through a single step of the foam molding process in which a plurality of cylinders are provided inside the foam mold. Making holes 28 using a foam mold saves on raw materials for the foam as foam is never formed in the area of the holes and is not discarded as when the holes are punched out. Yet another alternative method of making holes 28 is to drill into the molded foam with rotating bits.

Holes 28 may have circular or non-circular cross sections, such as ovals, polygons or triangles. By providing holes 28 in the center of middle portion 25, the amplitude of deformation of the foam is increased so as to decrease the contacting hardness of the foam. The softness of the center of middle portion 25 can be adjusted by varying the spacing and diameter of the holes 28 and by varying the depth of the holes where the holes are not through holes. For example, the holes can be spaced farther apart to increase the hardness. By decreasing the contacting hardness at the center of middle portion 25, the user's head sinks deeper into pillow 20. At the same time, support member 26 with firmer and higher-density foam than the molded foam of body 21 provides higher support for the user's neck, which allows the user's head to tilt back into pillow 20 and which opens the user's airways. Existing anti-snore pillows that provide inadequate support beneath the neck and that do not sufficiently tilt back the head cause the user to sleep with his chin close to his chest, which may result in a restricted airway. Sleeping with a restricted airway may cause snoring and lead to obstructive sleep apnea.

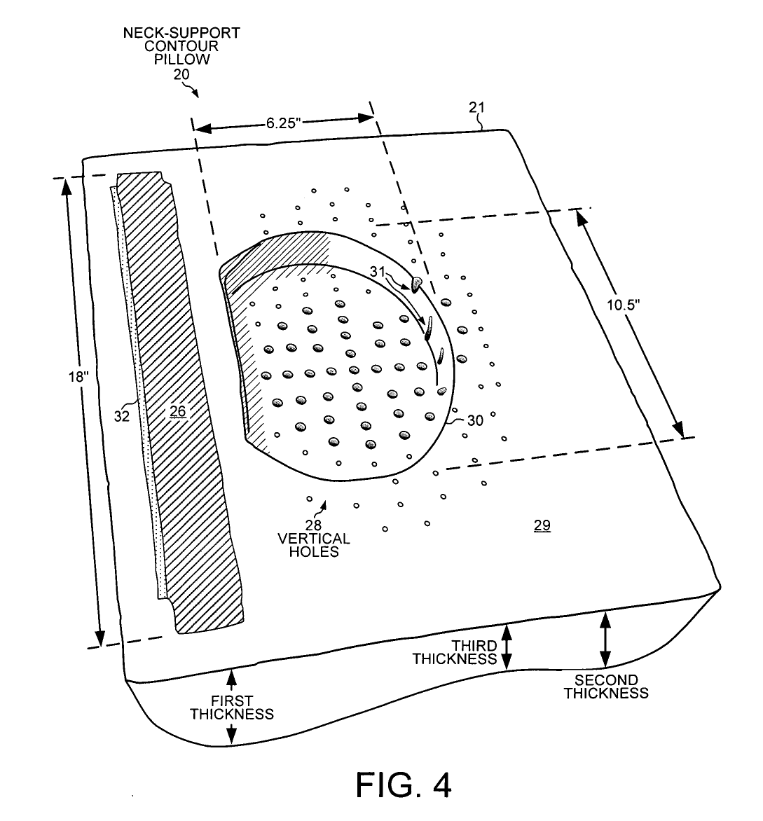

FIG. 4 shows a bottom perspective view of body 21 of molded foam. Body 21 has a substantially flat bottom surface 29 with an indentation 30 located at the center and opposite the concave curve of top surface 27. Most of vertical holes 28 exit bottom surface 29 inside indentation 30. The holes of the embodiment shown in FIG. 4 were punched through body 21 after the molded foam was formed as opposed to being made during the molding process by cylinders inside the mold. Consequently, FIG. 4 shows that some holes 31 were punched through the side walls of indentation 30. In one embodiment, indentation 30 is about 10.5 inches wide, 6.25 inches long and 1.5 inches deep.

FIG. 4 shows that the molded foam of body 21 conforms around support member 26 only on five of its six sides. Before the liquid mixed raw materials set up as the molded foam of body 21, the liquid raw materials flow around five of the six sides of support member 26. The liquid raw materials do not flow onto the surface of support member 26 that is shown in FIG. 4 because that surface is removably attached to the inside surface of the lid of the mold. In one embodiment, support member 26 is attached to the lid by needles on the lid that stick down into the foam. When the molded foam of body 21 sets up around support member 26 and the lid of the mold is removed, the needles pulls away from support member 26. FIG. 4 also shows a narrow strip 32 parallel to support member 26. Strip 32 is molded foam from which the outer skin has been torn away when the lid of the mold was removed. The cells of the memory foam can be seen in strip 32, whereas the other outer surfaces of the molded foam are covered by a smooth skin that forms adjacent to the inner surfaces of the mold.

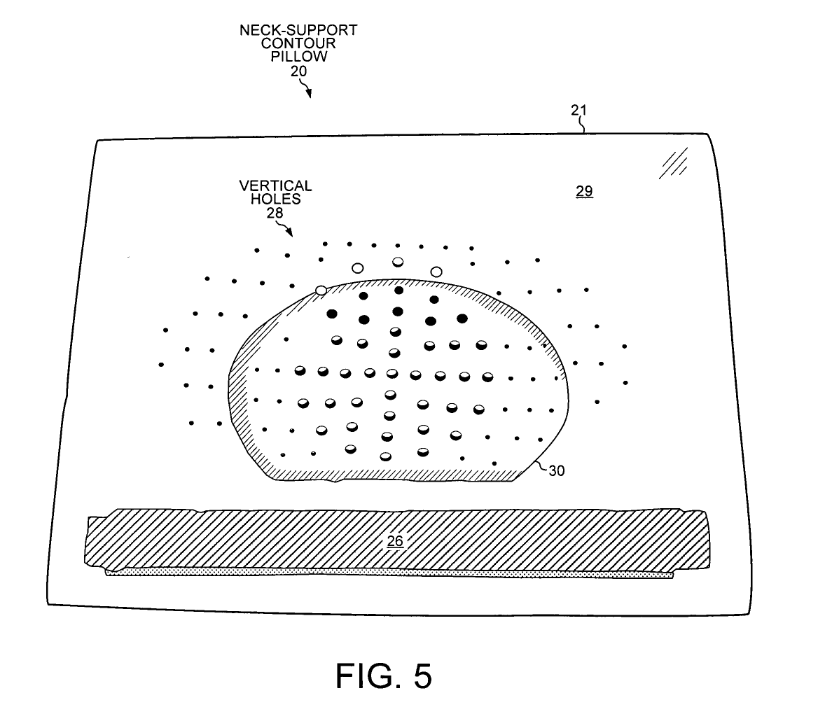

FIG. 5 shows another perspective view of the bottom of body 21 of molded foam. FIG. 5 shows that there are two sizes of the vertical holes 28. The holes at the center of the matrix of holes have a larger diameter than the holes towards the outside of the matrix of holes. Consequently, the ILD of the structure of body 21 is lower at the center of the matrix of holes than towards the outside of the matrix of holes. Moreover, the thickness of foam between indentation 30 and the concave curve of top surface 27 is thinner than elsewhere. Thus, the firmness of body 21 above indentation 30 and at the center of the matrix of holes 28 is further reduced. The combined effect of the dual sized holes 28 and indentation 30 causes the user's head to tilt back into the correct location on top surface 27. Indentation 30 reduces the thickness of foam only at the center of body 21, whereas groove 19 of prior art pillow 10 reduces the thickness of the foam through the entire length of the pillow, which contributes to hammocking.

In one embodiment, green tea powder and a green dye are added to the foam of body 21. A green dye is first added to the mixture of polyol raw materials that form the memory foam. The green tea powder that is added later is actually yellow and does not impart a green color to the green tea foam. Adding green dye to make body 21 look green adds to consumer awareness that pillow 20 contains green tea. The green tea additive decreases the smell of the memory foam chemicals in contour pillow 20. In addition, the bacteria, mites and mold that can live in the fabric of pillow covering 22 are killed when they come into contact with the green tea foam.

FIG. 6 shows fabric covering 22 enclosing body 21 of neck-support contour pillow 20. Fabric covering 22 includes a zipper parallel to support member 26 on bottom surface 29 (not shown in FIG. 6). Body 21 can be removed from fabric covering 22 through the opening created by the zipper.

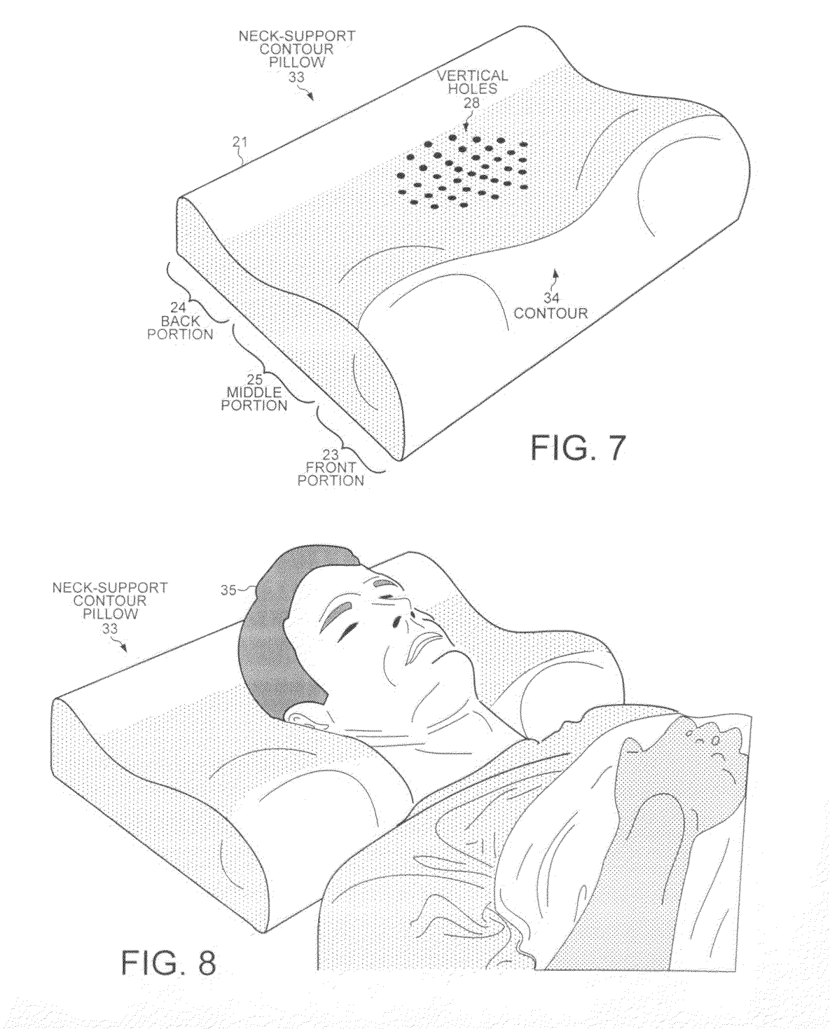

FIG. 7 shows another embodiment of a neck-support contour pillow 33. Body 21 of pillow 33 has a contour 34 in the center of front portion 23. Contour 34 is a concave curve in the center of the neck-support region that reduces side-to-side movement of the head of the user. The user's neck is relaxed during sleeping because the neck need not maintain the face-up orientation of the head. In addition, because support member 26 underneath contour 34 raises the neck, and vertical holes 28 and indentation 30 allow the head to sink into body 21 and tilt back, the user's airways are pulled open, and obstructive sleep apnea is reduced.

FIG. 8 shows the head 35 of a user resting on neck-support contour pillow 33. Vertical holes 28 and indentation 30 allow the user's head 35 to sink deeper into pillow 33. At the same time, support member 26 with firmer and higher-density foam provides more support for the user's neck and causes the user's head 35 to tilt back into pillow 33 and the user's airways to open.

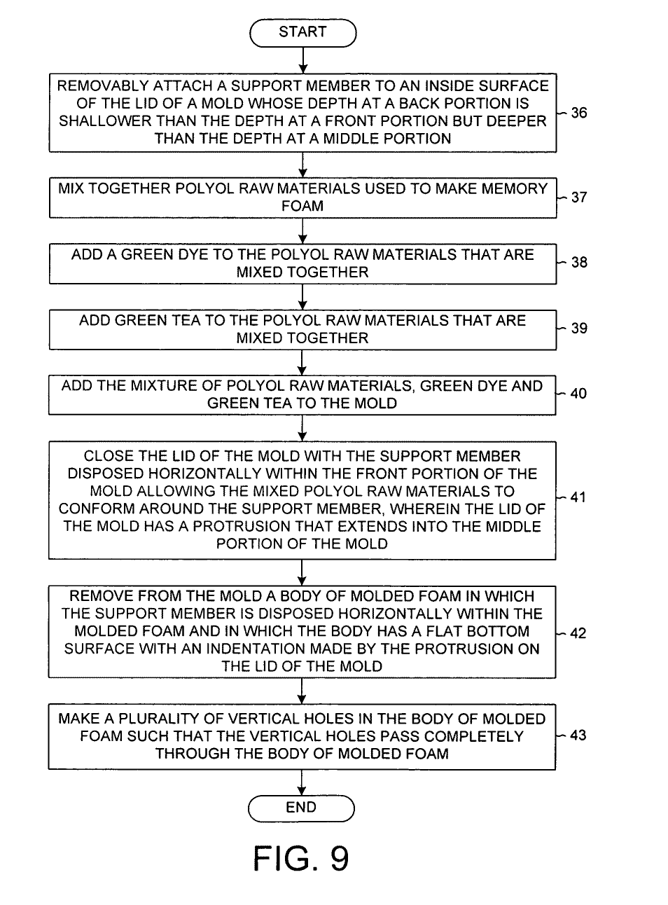

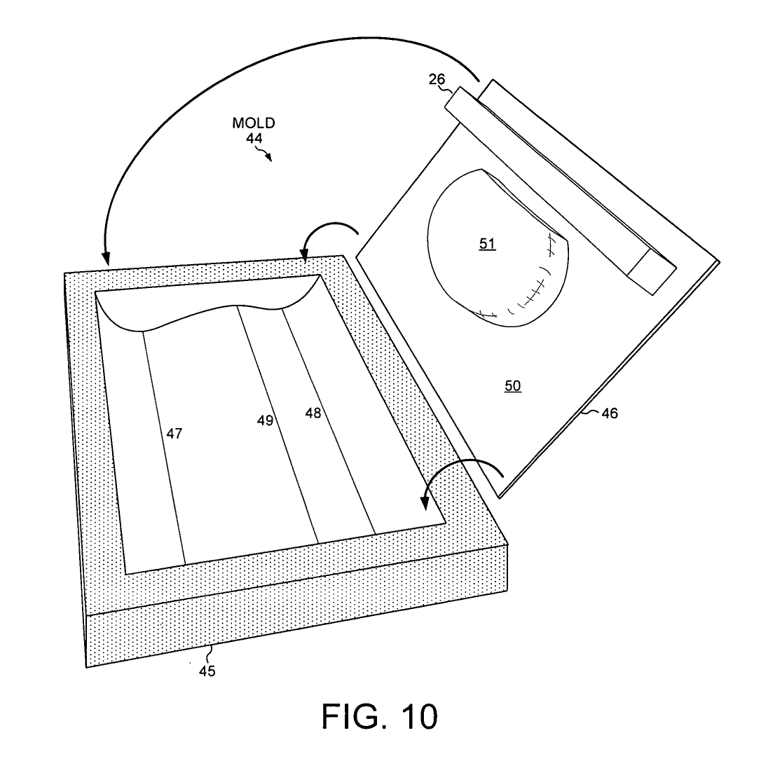

FIG. 9 is a flowchart illustrating steps 36-43 of a method making body 21 of neck-support contour pillow 20. The steps of FIG. 9 will now be described in relation to the operation of a mold 44 shown in FIG. 10. Mold 44 has a base 45 and a lid 46. The inside of base 45 of mold 44 has a front portion 47 with a first depth, a back portion 48 with a second depth, and a middle portion 49 with a third depth. The second depth is shallower than the first depth and deeper than the third depth.

In a first step 36, support member 26 is removably attached to the inside surface 50 of lid 46 of mold 44. In one embodiment, needles protrude from surface 50. Support member 26 is removably attached to surface 50 by pressing foam support member 26 into the needles.

In step 37, polyol raw materials used to make memory foam are mixed together. In one embodiment, three different polyol raw materials are mixed together; a memory foam polyol is mixed together with a polyol for polyurethane and a polymer polyol. The relative volumes of (i) the memory foam polyol, (ii) the polyol for polyurethane and (iii) a polymer polyol are 2:1:1. Different ratios result in memory foam having different densities and firmness. The three polyols are mixed for about 30 minutes.

In step 38, a green dye is added to the polyol raw materials that are mixed together.

In step 39, a green tea powder is added to the polyol raw materials that are mixed together, and the resulting mixture is agitated for about an additional thirty minutes. Measurable antimicrobial and antiodorant qualities in the green tea foam are achievable by adding green tea powder constituting even less than 2% of the weight of the resulting green tea foam. In one embodiment, green tea powder in an amount of about 0.1% of the total weight of prior mixture is added in step 39. In another embodiment, instead of green tea powder, a green tea water solution is added to the prior mixture. A volume of tea leaf powder or tea water solution accounts for about 1% to 15% of the total volume of the polyol raw materials.

In step 40, the mixed polyol raw materials, green dye and green tea are poured into the base 45 of mold 44. In another embodiment, the mixed polyol raw materials are injected into the mold after lid 46 is closed in step 41.

In step 41, lid 46 of mold 44 is closed such that support member 26 is disposed horizontally within front portion 47 of mold 44 when lid 46 is closed. When support member 26, which is attached to lid 46, is lowered into the mixed polyol raw materials in base 45, the mixed polyol raw materials conform around five of the six sides of support member 26. In another embodiment, the mixture of polyol raw materials, green tea and green dye are injected into mold 44 after lid 46 is already closed. Lid 46 of mold 44 has a protrusion 51 that extends into middle portion 49 of mold 44 when lid 46 is closed. The mixed polyol raw materials are then allowed to cure.

In step 42, body 21 of molded foam is removed from mold 44. When lid 46 is opened, the needles that held support member 26 in place pull out leaving the support member disposed horizontally within the molded foam of body 21. Body 21 has a flat bottom surface, which is face up in base 45, with indentation 30 located at the center of middle portion 25. Indentation 30 is made by protrusion 51 in lid 46. Body 21 is then removed from base 45.

In step 43, a plurality of vertical holes 28 are made in body 21 of molded foam that pass completely through body 21. Holes 28 are punched through the center of middle portion 25. Most of holes 28 pass through indentation 30.

Body 21 of molded foam is then placed in pillow covering 22. Support member 26 provides a means for increasing the firmness of the foam in front portion 23 of body 21, whereby the molded foam conforms around the foam of support member 26. Vertical holes 28 and indentation 30 provide a means for decreasing the firmness of body 21 of molded foam in middle portion 25. Support member 26 supports the neck of the user, whereas vertical holes 28 and indentation 30 allows the head 35 of the user to sink into middle portion 25 of body 21 of molded foam. The green tea powder added to the memory foam raw materials provides a means for controlling bacterial, germ and mold growth on body 21 and in fabric covering 22 and for absorbing the odors of the memory foam chemicals.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A pillow comprising:
a body of molded foam, wherein a front portion of the body has a first thickness, a back portion of the body has a second thickness, and a middle portion of the body has a third thickness, wherein the second thickness is thinner than the first thickness and thicker than the third thickness, wherein a support member is disposed horizontally within the front portion, and wherein the molded foam of the body conforms around the support member; and
a fabric covering that encloses the body.

2. The pillow of claim 1, wherein the support member is made of foam having a hardness greater than that of the molded foam of the body.

3. The pillow of claim 1, wherein the support member is foam cut from a foam slab.

4. The pillow of claim 1, wherein a plurality of vertical holes pass completely through the body of molded foam at the middle portion of the body.

5. The pillow of claim 1, wherein the body of molded foam has a top surface, and wherein the top surface has a concave curve between the front portion and the back portion.

6. The pillow of claim 5, wherein the body of molded foam has a substantially flat bottom surface, and wherein the bottom surface has an indentation located opposite the concave curve of the top surface.

7. The pillow of claim 1, wherein the molded foam has an ILD in a range of 6-10, and wherein the support member is made of foam with an ILD in a range of 12-14.

8. The pillow of claim 1, wherein the molded foam is visco-elastic foam, and wherein the support member is made of high-density foam.

9. The pillow of claim 1, wherein the visco-elastic foam contains green tea and a green dye.

10. A method comprising:
removably attaching a support member to an inside surface of a lid of a mold, wherein a front portion of the mold has a first depth, a back portion of the mold has a second depth, and a middle portion of the mold has a third depth, wherein the second depth is shallower than the first depth and deeper than the third depth;
mixing polyol raw materials together, wherein the polyol raw materials are used to make memory foam;
adding the mixed polyol raw materials to the mold; and
closing the lid of the mold, wherein the support member is disposed horizontally within the front portion of the mold when the lid of the mold is closed, and wherein the mixed polyol raw materials conform around the support member.

11. The method of claim 10, wherein the closing the lid is performed before the adding the mixed polyol raw materials.

12. The method of claim 10, further comprising:
removing from the mold a body of molded foam in which the support member is disposed horizontally within the molded foam; and
making a plurality of vertical holes in the body of molded foam, wherein the plurality of vertical holes pass completely through the body of molded foam.

13. The method of claim 12, wherein the molded foam has an ILD in a range of 6-10, and wherein the support member is made of foam with an ILD in a range of 12-14.

14. The method of claim 12, wherein the body of molded foam has a front portion with a first thickness, a back portion with a second thickness, and a middle portion with a third thickness, wherein the second thickness is thinner than the first thickness and thicker than the third thickness, wherein the support member is disposed horizontally within the front portion, and wherein the plurality of vertical holes pass through the middle portion.

15. The method of claim 10, wherein the lid of the mold has a protrusion that extends into the middle portion of the mold when the lid of the mold is closed.

16. The method of claim 15, further comprising:
removing a body of molded foam from the mold, wherein the body of molded foam has a top surface with a concave curve between a front portion and a back portion of the body of molded foam, wherein the body of molded foam has a substantially flat bottom surface, wherein the bottom surface has an indentation made by the protrusion on the lid of the mold, and wherein the indentation is located opposite the concave curve of the top surface.

17. The method of claim 10, further comprising:
adding green tea to the polyol raw materials that are mixed together; and
adding a green dye to the polyol raw materials that are mixed together.

18. A pillow comprising:
a body of molded foam, wherein a front portion of the body has a first thickness, a back portion of the body has a second thickness, and a middle portion of the body has a third thickness, wherein the second thickness is thinner than the first thickness and thicker than the third thickness, and wherein the molded foam has a firmness corresponding to an ILD in a range of 6-10; and
means for increasing the firmness of the body of molded foam in the front portion of the body, wherein the molded foam of the body conforms around the means.

19. The pillow of claim 18, further comprising:
means for decreasing the firmness of the body of molded foam in the middle portion of the body.

20. The pillow of claim 18, wherein a head of a user lying supine rests on the pillow, wherein the means for increasing the firmness of the body of the molded foam supports the neck of the user, and wherein the means for decreasing the firmness of the body of the molded foam allows the head of the user to sink into the middle portion of the body of molded foam.
